(19) United States
(12) Patent Application Publication
(10) Pub. No.: US 2013/0108229 A1
(43) Pub. Date: May 2, 2013

(54) HEADS-UP DISPLAY INCLUDING AMBIENT LIGHT CONTROL

(71) Applicants: Thad E. Starner, Mountain View, CA (US); Edward Keyes, Mountain View, CA (US); Chia-Jean Wang, Palo Alto, CA (US); Xiaoyu Miao, Sunnyvale, CA (US); Mark B. Spitzer, Sharon, MA (US)

(72) Inventors: Thad E. Starner, Mountain View, CA (US); Edward Keyes, Mountain View, CA (US); Chia-Jean Wang, Palo Alto, CA (US); Xiaoyu Miao, Sunnyvale, CA (US); Mark B. Spitzer, Sharon, MA (US)

(73) Assignee: GOOGLE INC., Mountain View, CA (US)

(21) Appl. No.: 13/284,743

(22) Filed: Oct. 28, 2011

(51) Int. Cl. G02B 6/06

(52) U.S. Cl. 385/119

(57) ABSTRACT

Implementations are described of a waveguide apparatus including a proximal end, a distal end, a front surface and a back surface, the back surface being spaced apart from the front surface. A display input region is positioned at or near the proximal end, an ambient input region is positioned on the front surface near the distal end and an output region is positioned on the back surface near the distal end. One or more optical elements is positioned in or adjacent to the waveguide to direct display light from the display input region to the output region and to direct ambient light from the ambient input region to the output region, and an switchable mirror layer is positioned in or on the waveguide to selectively control the amount of ambient light that is directed to the output region. Other embodiments are disclosed and claimed.

### TECHNICAL FIELD

The described embodiments relate generally to heads-up displays and in particular, but not exclusively, to a heads-up display including ambient light control.

### BACKGROUND

Heads-up displays allow a user to view a scene that is in front of them while relevant information is overlayed on the scene, so that the user looking through the heads-up display simultaneously sees both the scene and the relevant information. For example, a pilot looking through a heads-up display while landing an airplane simultaneously sees the airport ahead (the scene) through the heads-up display while the heads-up display projects information such as speed, heading and altitude (the relevant information) that the pilot needs to land the plane.

A potential problem with heads-up displays is that there can be competition or rivalry between the scene and the displayed information. One example of rivalry occurs when the scene is much brighter than the displayed information, so that the scene overwhelms the information and makes the dimmer information hard to see when viewed against the brighter scene. The opposite can happen too: the information can be much brighter than the scene, making the dimmer scene hard to see when viewed through the bright information shown in the display.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a cross-sectional view of an embodiment of a heads-up display.

FIG. 2 is a cross-sectional view of another embodiment of a heads-up display.

FIG. 3 is a cross-sectional view of another embodiment of a heads-up display.

FIG. 4 is a cross-sectional view of another embodiment of a heads-up display.

FIGS. 5A-5C are views of embodiments of patterning of a switchable mirror layer in a heads-up display.

FIG. 6 is a cross-sectional view of another embodiment of a heads-up display.

FIGS. 7A-7B are cross-sectional drawings of an embodiment of a process for making a heads-up display.

FIG. 8 is a top-view cross-sectional drawing of an embodiment of a heads-up display.

### DETAILED DESCRIPTION OF THE ILLUSTRATED EMBODIMENTS

Embodiments of an apparatus, system and method for a heads-up display including ambient light control are described. Numerous specific details are described to provide a thorough understanding of embodiments of the invention, but one skilled in the relevant art will recognize that the invention can be practiced without one or more of the specific details, or with other methods, components, materials, etc. In some instances, well-known structures, materials, or operations are not shown or described in detail but are nonetheless encompassed within the scope of the invention.

Reference throughout this specification to “one embodiment” or “an embodiment” means that a particular feature, structure, or characteristic described in connection with the embodiment is included in at least one described embodiment. Thus, appearances of the phrases “in one embodiment” or “in an embodiment” in this specification do not necessarily all refer to the same embodiment. Furthermore, the particular features, structures, or characteristics may be combined in any suitable manner in one or more embodiments.

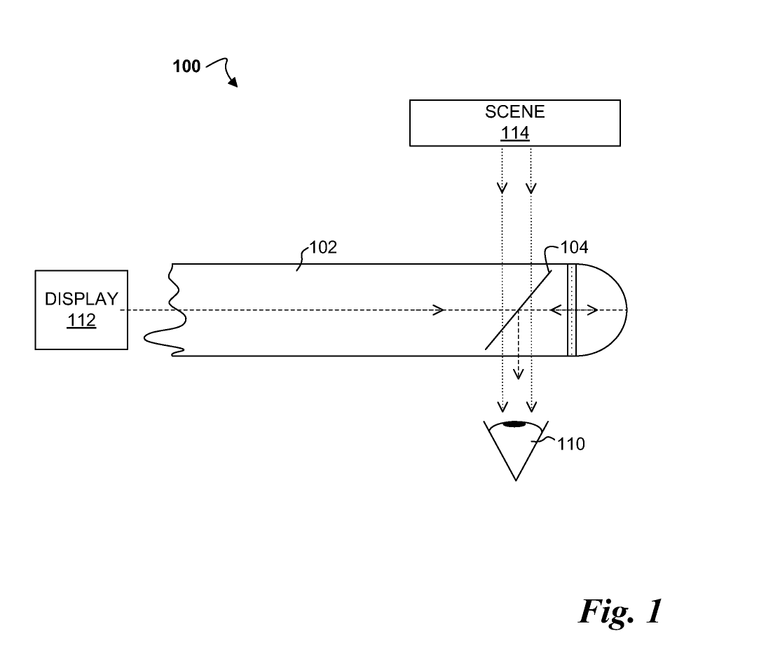

FIG. 1 illustrates an embodiment of a heads-up display 100. Display 100 includes a waveguide 102 within which is positioned an optical element 104 that allows light from a display 112, as well as ambient light from a scene 114, to be directed into an eye 110 of the user of the display. In some instances, light from the scene will be substantially brighter than light from the display, making the information from the display hard for the user to see.

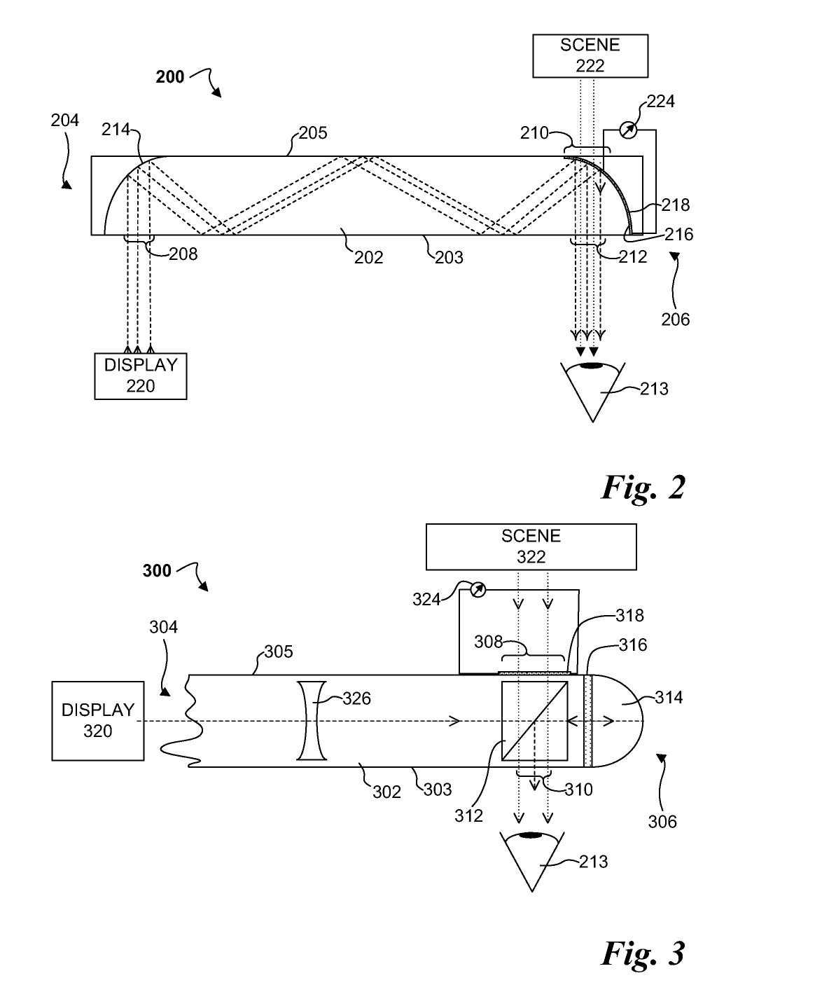

FIG. 2 illustrates another embodiment of a heads-up display 200. Display 200 includes a waveguide 202 having a back surface 203, a front surface 205, a proximal end 204 and a distal end 206. As used in this application, the term “waveguide” includes any device capable of containing and/or directing electromagnetic energy from one place to another by any mechanism or combination of mechanisms, such as transmission, reflection, total internal reflection, refraction and diffraction. Waveguide 202 can be made of any kind of material that is substantially transparent in the wavelengths of interest; in one embodiment, for example, waveguide 202 can be made of plastic such as polycarbonate, but in other embodiments it could be made of a different material such as glass. Positioned on back surface 203 at or near the proximal end 204 is display input region 208 to receive light from display 220. In different embodiments, display 220 can be an LCOS panel, an LCD panel, an OLED panel, or some other kind of display. Similarly, at or near distal end 206 are an ambient input region 210 positioned on front surface 205 to receive ambient light from the scene 222 and an output region 212 positioned on back surface 203 to output both display light and ambient light to one or both eyes 213 of a user.

Within waveguide 202 are an optical element 214 near proximal end 204 and an optical element 216 near distal end 206. Optical element 214 is positioned to receive light that enters waveguide 202 through display input region 208 and redirect and/or focus the received light within waveguide 202 so that it travels through the waveguide toward optical element 216. In other words, optical element 214 can have optical power, meaning that it can focus light by making light rays converge or diverge. In the illustrated embodiment, optical element 214 can be a curved internal surface that forms a focusing mirror, but in other embodiments it could be some other type of optical element.

Optical element 216 is positioned near the distal end 206 so that it can reflect and/or focus light received to the waveguide 202 from display 220 toward output region to 212, so that the display light is directed toward user eye 213. Simultaneously, optical element 216 allows ambient light from scene 222 that enters waveguide 202 through ambient input region 210 to travel through the waveguide and through output region 212 to user eye 213. In the illustrated embodiment, optical element 216 is an internal surface with optical power—that is, it can focus light by making light rays converge or diverge—that can reflect and/or focus display light received through waveguide 202 while allowing ambient light from scene 222 to propagate through to eye 213. In one embodiment optical element 216 can be a half-silvered mirror, but in other embodiments optical element 216 could be some other type of optical element such as a polarization beamsplitter or a surface with some other type of coating.

Optical element 216 can also include a switchable mirror layer 218 formed over at least a portion of the optical element. A switchable mirror layer (a layer of switchable mirror material) is a layer whose opacity can be changed by applying an electrical bias to the layer. Examples of switchable mirror materials include liquid crystal materials available from Kent Optronics of Hopewell Junction, N.Y. A variable and controllable electrical bias source 224 is coupled to switchable mirror layer 218 to allow control of the layer's opacity. In one embodiment, the opacity of switchable mirror layer 218 will be directly related to the amount of electrical bias applied, such that the opacity of the switchable mirror layer can be set anywhere along a continuum from an essentially transparent state where the layer lets substantially all light through to a completely opaque state where the layer lets no light at all through.

In operation of heads-up display 200, light generated by display 220 is directed toward display input region 208 such that it enters waveguide 202. After entering waveguide 202, the light is redirected and/or focused by optical element 214 to travel through waveguide 202 toward optical element 216. Upon receiving light from waveguide 202, optical element 216 redirects and/or focuses the display light toward output region 212, where the display light then exits the waveguide 202 and enters the user's eye 213.

Simultaneously with receiving light from display 220, waveguide 202 receives ambient light from scene 222 through ambient input region 210. If the electrical bias applied to switchable mirror layer 218 is such that the layer is substantially transparent, then substantially all the ambient light that enters through ambient input region 210 will travel through switchable mirror layer 218 and a portion of the light will travel through optical element 216 and exit the waveguide 202 through output region 212 to user's eye 213. If the electrical bias applied to switchable mirror layer 218 is such that the layer is substantially opaque, then substantially none of the ambient light that enters through ambient input region 210 will end up exiting the waveguide through output region 212. If the electrical bias applied to switchable mirror layer 218 makes the layer partially opaque, then only some portion of the light that enters through ambient input region 210 will end up exiting the waveguide through output region 212. By thus controlling the amount of ambient light that goes to the user's eye 213, the display light can be emphasized over the ambient light from the scene. In other embodiments, the brightness of display 220 can also be controlled, providing an additional way of balancing the display and scene brightnesses.

FIG. 3 illustrates another embodiment of a heads-up display 300. Display 300 includes a waveguide 302 having a back surface 303, a front surface 305, a proximal end 304 and a distal end 306. Waveguide 302 can be made of any kind of material that is substantially transparent in the wavelengths of interest; in one embodiment, for example, waveguide 302 can be made of a plastic such as polycarbonate, but in other embodiments it could be made of a different material such as glass. Although not shown in this figure, a display input region is positioned on the waveguide at or near proximal end 304. The display input region is optically coupled to display 320 so that display light is input into waveguide 320. Near distal end 306 are an ambient input region 308 positioned on front surface 305 to receive ambient light from a scene 322 and an output region 310 positioned on back surface 303 to output both display light and ambient light to one or both eyes 213 of a user.

Positioned at or near distal end 306 are optical elements 312, 314 and 316, which work together to receive light from display 320 that travels through waveguide 302 and redirect the received light toward output region 310, so the display light is directed toward user eye 213. Optical elements 312 simultaneously allows ambient light from scene 322 that enters waveguide 302 through ambient input region to 308 to travel through the waveguide and exit through output region 310 to a user's eye 213.

In the illustrated embodiment of display 300, optical element 312 is a polarizing beamsplitter. Beamsplitter 312 is optically coupled to a focusing mirror 314 positioned at the distal end 306, as well as to a quarter-wave plate 316 sandwiched between optical element 314 and the distal end. In other embodiments optical elements 312, 314 and 316 can be other types of optical elements provided that the individual element and their combination accomplish the desired result.

Positioned on front surface 305 over at least part of ambient input region 308 is a switchable mirror layer 318. A variable and controllable electrical bias source 324 is coupled to switchable mirror layer 318 to allow the layer's opacity to be controlled by changing the applied electrical bias. Generally, the opacity of switchable mirror layer 318 will be related to the amount of applied electrical bias, such that by changing the applied electrical bias the opacity of the switchable mirror layer can be set anywhere along a continuum from an essentially transparent state where the switchable mirror layer lets substantially all light through to a completely opaque state where the switchable mirror layer lets no light at all through.

In operation of heads-up display 300, polarized light generated by display 320 enters waveguide 302 at or near proximal end 304 and travels through the waveguide to distal end 306, where it encounters polarizing beamsplitter 312. When display light from waveguide 302 impinges on polarizing beamsplitter, the beamsplitter allows the polarized light to travel directly through it. The light traveling through beamsplitter 312 travels through quarter-wave plate 316, which rotates the polarization by 45 degrees, and then encounters focusing mirror 314. Focusing mirror 314 reflects and/or focuses the polarized light, directing it back through quarter-wave plate 316. On it second trip through quarter-wave plate 316, the polarized light has its polarization rotated by a further 45 degrees, so that upon encountering polarizing beamsplitter again the polarization of the display light has been rotated by a total of 90 degrees. As a result of this 90-degree change of polarization, when the display light encounters polarizing beamsplitter 312 a second time the beamsplitter reflects the display light toward output region 310 instead of allowing in to pass through. The display light then exits the waveguide 302 and enters the users eye 213.

Simultaneously with receiving light from display 320, waveguide 302 can receive unpolarized ambient light from scene 322 through ambient input region 308, depending on the state of switchable mirror layer 318. If the electrical bias applied to switchable mirror layer 318 is such that the layer is substantially transparent, then substantially all ambient light that enters through ambient input region 308 will travel through switchable mirror layer 318 and polarizing beamsplitter 312 and exits the waveguide through output region 310 to user's eye 213. If the electrical bias applied to switchable mirror layer 318 is such that the layer is substantially opaque, then substantially no ambient light enters through ambient input region 210. If the electrical bias applied to switchable mirror layer 318 makes the layer partially opaque, then only some fraction of the ambient light from scene 322 enters through ambient input region 308 and ends up exiting the waveguide through output region 310. By thus controlling the amount of ambient light that goes to the user's eye 213, the display light can be emphasized over the ambient light from the scene.

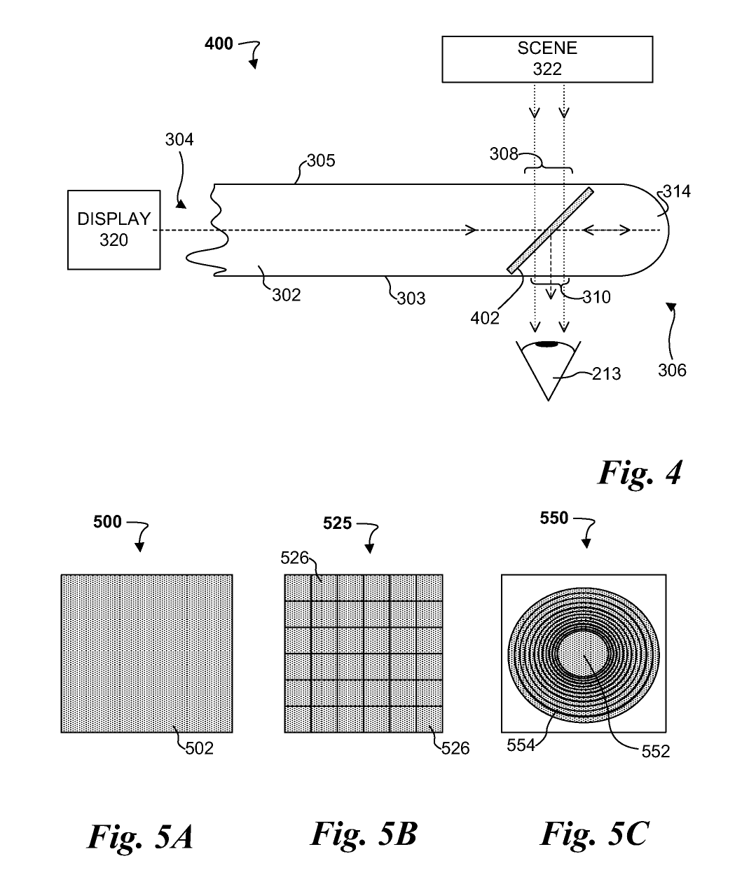

FIG. 4 illustrates another embodiment of a heads-up display 400. Display 400 is similar in construction to display 300, the primary difference being that display 400 uses a partially-reflective mirror 402 instead of a polarizing beam splitter. As a result of replacing the polarizing beam splitter, display 400 also omits quarter-wave plate 316. In one embodiment partially-reflective mirror 402 is 50% reflective, meaning that is reflects 50% of the incident light and allows the other 50% of the incident light to pass through. In other embodiments, however, these percentages can be different. In the illustrated embodiment, partially-reflective mirror 402 can be formed solely of a switchable mirror layer, so that an appropriate electrical bias can be applied to control the relative brightness of display light and ambient light. In other embodiments, a partially-reflective mirror such as a half-silvered mirror could be used together with a switchable mirror layer formed over at least part of ambient input region 308, as in display 300.

In operation of display 400, light generated by display 320 enters waveguide 302 at or near proximal end 304 and travels through the waveguide to distal end 306, where it encounters partially-reflective mirror 402. When display light impinges on the partially-reflective mirror, the mirror allows some fraction of the incident light to travel through it. The display light traveling through partially-reflective mirror then encounters focusing mirror 314, which reflects and/or focuses the light and directs it back toward the partially-reflective mirror. When the display light encounters partially-reflective mirror 402 a second time, the partially-reflective mirror allows part of the reflected display light through and reflects the rest of the display light toward output region 310. The display light then exits the waveguide 302 and enters the user's eye 213.

Simultaneously with receiving light from display 320, partially-reflective mirror 402 can receive ambient light from scene 322 through ambient input region 308. If the electrical bias applied to partially-reflective mirror 402 is such that it is substantially transparent, then none of the display light arriving at the partially-reflective mirror will be directed toward output region 310, while substantially all ambient light that enters through ambient input region 308 will pass through the partially-reflective mirror and exit the waveguide through output region 310 to user's eye 213. The partially-reflective mirror would effectively vanish from the user's view, which would have an advantage when the display is off. If the electrical bias applied to partially-reflective mirror 402 is such that the mirror is substantially opaque, then substantially none of the light incident on partially-reflective mirror 402, whether display light or ambient light, will be allowed to pass through.

If the electrical bias applied to partially-reflective mirror 402 makes the mirror partially opaque, then only some fraction of the display light and ambient light incident on partially-reflective mirror 402 end up exiting the waveguide through output region 310. For example, the bias could be set for 50% transmission, in which case partially-reflective mirror 402 would act like a 50% (half-silvered) mirror. The ambient light from the scene would be attenuated by 50%, and the display light would be attenuated by 75%. Alternatively, the bias could be set to make partially-reflective mirror 402 90% transmissive and 10% reflective; in that case, 90% of the ambient light would exit through output region 310, but only 9% of the display light would exit through the output region. By thus using partially-reflective mirror 402 to control the amount of ambient light that goes to the user's eye 213, the display light can be emphasized over the ambient light from the scene.

FIGS. 5A-5C illustrate embodiments of patterning that can be used for the switchable mirror layer in any of the embodiments of a heads-up display described in this application. FIG. 5A illustrates a pattern 500 in which the switchable mirror layer includes a single region 502 that covers at least a part of whatever component it is formed on. When an electrical bias is applied to region 502, the entire region changes its opacity, such that the opacity change is substantially uniform over the entire area. FIG. 5B illustrates another embodiment of a pattern 525 in which the switchable mirror layer is divided into a plurality of abutting individual sub-regions or tiles. In one embodiment, each tile can be individually controllable by an electrical bias source, while in other embodiments the tiles can be divided into groups, each group being separately controllable. By controlling the switchable mirror tiles individually or in groups, light can be directed to parts of an output region but not others. FIG. 5C illustrates another embodiment of a pattern 550 in which the switchable mirror layer is divided into a circular central region 552 surrounded by a plurality of abutting switchable mirror annuluses 554. In one embodiment central region 552, as well as each of the annuluses 554, can be individually controllable by an electrical bias source, but in other embodiments the different switchable mirror areas can be grouped and controlled together.

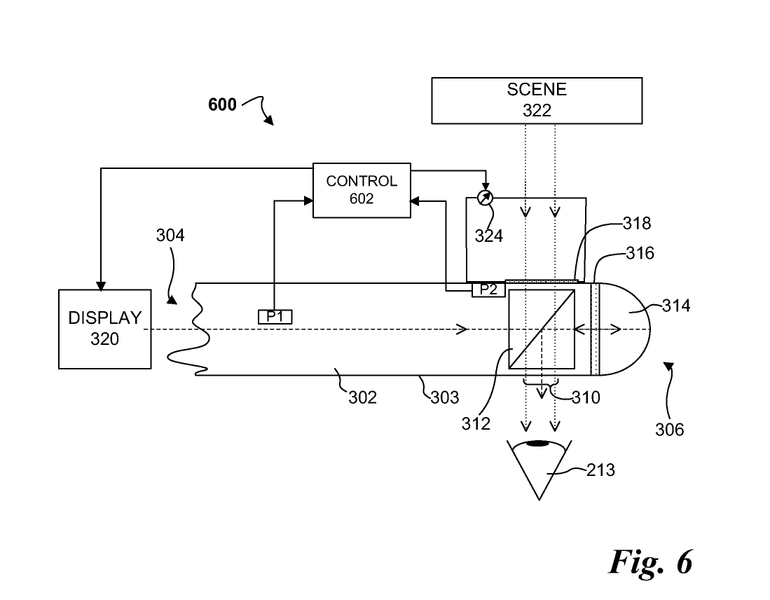

FIG. 6 illustrates another embodiment of a heads-up display 600. Display 600 is similar to display 300, the primary difference being the addition in display 600 of a control system 602. A first photodetector P1 is positioned in or on waveguide 302 where it can measure the intensity of the display light. A second photodetector P2 is positioned in or on waveguide 302 where it can measure the intensity of the ambient light from scene 322. In various embodiments each of photodetectors P1 and P2 can be a photodiode, a phototransistor, a photoresistor, an image sensor, or some other type of sensor capable of measuring light. In one embodiment P1 and P2 can be the same type of sensor, but in other embodiments they need not be the same.

Both first photodetector P1 and second photodetector P2 are coupled to a control circuit 602, which includes circuitry and logic therein to monitor and evaluate the inputs it receives from P1 and P2 and use these inputs to generate a control signal which it can then use to control electrical bias source 324 and/or display 320 to automatically balance the relative brightness of the two.

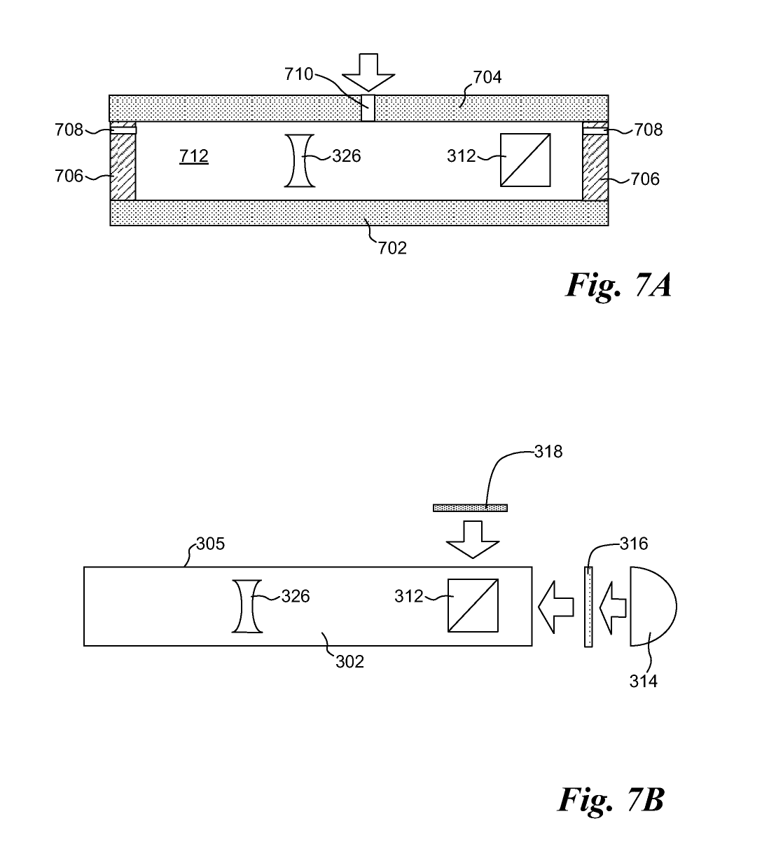

FIGS. 7A-7B illustrate an embodiment of a process for making heads-up display 300. The illustrated process can also be used for making the other displays disclosed herein. FIG. 7A illustrates a first part of the process, in which a mold is formed using a lower plate 702 and an upper plate 704 separated by one or more spacers 706. The mold encloses a volume 712. Top plate 704 has a hole 710 therein to allow material to be injected into volume 712, while spacers 706 have a vent hole 708 to allow gas to escape from volume 712 while material is injected.

Optical elements that will be internal to the waveguide, such as polarizing beamsplitter 312 and additional optical element 326, if present, are properly positioned within volume 712 and fixed so that they do not move. A material is then injected through hole 710 into volume 712 so that it surrounds the internal optical elements, and the material is allowed to cure. When cured, the material will hold the optical elements in place. Any material that has the required optical characteristics can be used; in one embodiment, for example, the material can be a plastic such as polycarbonate.

FIG. 7B illustrates a next part of the process. After the material is cured inside the mold, the mold can be removed leaving behind waveguide 302. Elements of the heads-up display that go on the exterior of the waveguide can then be added to complete the display. For example, switchable mirror layer 318 can be deposited on front side 305 of the waveguide, while quarter-wave plate 316 and 314 can be attached to the distal end of the waveguide using optically compatible adhesives that will hold the components in place while causing little or no optical distortion. The display unit (not shown) can then be optically coupled to the proximal end of the waveguide.

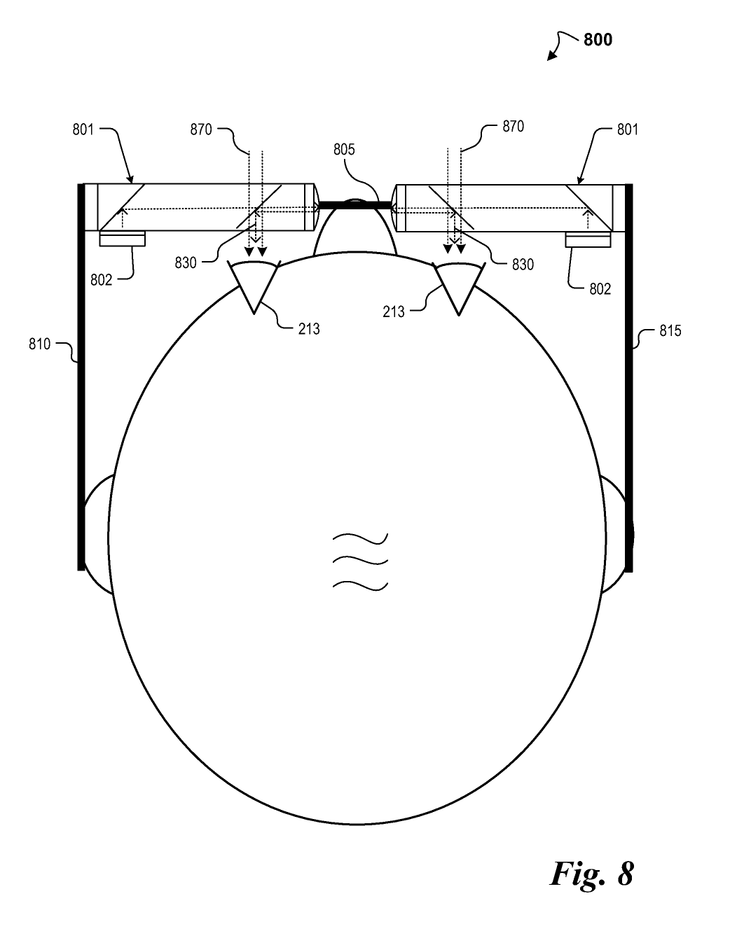

FIG. 8 is a top view of an embodiment of a heads-up display 800 implemented as a pair of eyeglasses. Heads-up display 800 includes a pair of eyepieces 801, each of which can be one of heads-up displays 200, 300, 400 or 600 in which the eyeglass lens functions as the waveguide. Eyepieces 801 are mounted to a frame assembly, which includes a nose bridge 805, a left ear arm 810, and a right ear arm 815. Although the figure illustrates a binocular embodiment (two eyepieces), heads-up display 800 can also be implemented as a monocular (one eyepiece) embodiment.

Eyepieces 801 are secured into an eye glass arrangement that can be worn on a user's head. Left and right ear arms 810 and 815 rest over the user's ears while nose assembly 805 rests over the user's nose. The frame assembly is shaped and sized to position a viewing region 830 in front of a corresponding eye 213 of the user. Of course, other frame assemblies having other shapes may be used (e.g., a visor with ear arms and a nose bridge support, a single contiguous headset member, a headband, or goggles type eyewear, etc.).

The viewing region of each eyepiece 801 allows the user to see an external scene via ambient light 870. Left and right display light 830 can be generated by displays 802 coupled to eyepieces 801, so that display light 830 is seen by the user as images superimposed over the external scene. Ambient light 870 can be blocked or selectively blocked using switchable mirror layers within the eyepieces.

The above descriptions of embodiments of the invention, including what is described in the abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description.

The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A waveguide apparatus comprising:
a proximal end, a distal end, a front surface and a back surface, the back surface being spaced apart from the front surface;
a display input region at or near the proximal end;
an ambient input region on the front surface near the distal end and an output region on the back surface near the distal end;
one or more optical elements positioned in or adjacent to the waveguide to direct display light from the display input region to the output region and to direct ambient light from the ambient input region to the output region; and
a switchable mirror layer positioned in or on the waveguide to selectively control the amount of ambient light that is directed to the output region.

2. The apparatus of claim 1 wherein the one or more optical elements include an internal surface with optical power.

3. The apparatus of claim 2 wherein the switchable mirror layer is positioned on the internal surface.

4. The apparatus of claim 1 wherein the switchable mirror layer can regulate the amount of ambient light to be directed to the output region.

5. The apparatus of claim 4 wherein the switchable mirror layer is controlled using a variable electrical bias.

6. The apparatus of claim 4 wherein the switchable mirror layer can allow substantially all ambient light to be directed to the output region and can allow substantially no ambient light to be directed to the output region.

7. The apparatus of claim 1 wherein the one or more optical elements include a polarizing beam splitter.

8. The apparatus of claim 7 wherein the switchable mirror layer is formed on the front surface over at least a portion of the ambient input region.

9. The apparatus of claim 8, one or more optical elements further include:
a focusing element positioned at the distal end of the waveguide; and
a quarter-wave plate positioned between the focusing element and the distal end of the waveguide.

10. The apparatus of claim 1 wherein the one or more optical elements include a partially-reflective mirror.

11. The apparatus of claim 9 wherein the switchable mirror layer is formed on the partially-reflective mirror.

12. The apparatus of claim 1 wherein the switchable mirror layer is patterned with individually controllable regions to selectively direct the ambient light to portions of the output region.

13. The apparatus of claim 12 wherein the switchable mirror layer is patterned with a plurality of abutting switchable mirror tiles.

14. The apparatus of claim 12 wherein the switchable mirror layer is patterned with a central switchable mirror circle surrounded by a plurality of abutting concentric switchable mirror annuluses of increasing radius.

15. The apparatus of claim 1, further comprising:
a first photosensor to measure the intensity of the display light;
a second photosensor to measure the intensity of the ambient light;
a control circuit coupled to the first photo sensor and the second photosensor, to a display optically coupled to the waveguide, and to a variable and controllable electrical bias source.

16. A system comprising:
a waveguide comprising:
a proximal end, a distal end, a front surface and a back surface, the back surface being spaced apart from the front surface,
a display input region at or near the proximal end,
an ambient input region on the front surface near the distal end and an output region on the back surface near the distal end,
one or more optical elements positioned in or adjacent to the waveguide to direct display light from the display input region to the output region and to direct ambient light from the ambient input region to the output region, and
a switchable mirror layer positioned in or on the waveguide to selectively control the amount of ambient light that is directed to the output region;
a display optically coupled to the display input region; and
a controllable electrical bias source coupled to the switchable mirror layer.

17. The system of claim 16 wherein the one or more optical elements include an internal surface with optical power.

18. The system of claim 17 wherein the switchable mirror layer is positioned on the internal surface.

19. The system of claim 16 wherein the switchable mirror layer can be controlled using the electrical bias source to regulate the amount of ambient light to be directed to the output region.

20. The system of claim 19 wherein the switchable mirror layer can allow substantially all ambient light to be directed to the output region and can allow substantially no ambient light to be directed to the output region.

21. The system of claim 16 wherein the one or more optical elements include a polarizing beam splitter.

22. The system of claim 21 wherein the switchable mirror layer is formed on the front surface and covers at least a portion of the ambient input region.

23. The system of claim 22, further comprising:
a focusing element positioned at the distal end of the waveguide; and
a quarter-wave plate positioned between the focusing element and the distal end of the waveguide.

24. The system of claim 16 wherein the one or more optical elements include a partially-reflective mirror.

25. The system of claim 24 wherein the switchable mirror layer is formed on the partially-reflective mirror.

26. The system of claim 16 wherein the switchable mirror layer is patterned with individually controllable regions coupled to the electrical bias source to selectively direct the ambient light to portions of the output region.

27. The system of claim 26 wherein the switchable mirror layer is patterned with a plurality of abutting switchable mirror tiles.

28. The system of claim 26 wherein the switchable mirror layer is patterned with a central switchable mirror circle surrounded by a plurality of abutting concentric switchable mirror annuluses of increasing radius.

29. The system of claim 16, further comprising:
a first photosensor to measure the intensity of the display light;
a second photosensor to measure the intensity of the ambient light; and
a control circuit coupled to the first photo sensor and the second photosensor, to the display, and to the controllable electrical bias source.

30. A process comprising:
positioning a waveguide in front of at least one eye of a user, the waveguide comprising:
a proximal end, a distal end, a front surface and a back surface, the back surface being spaced apart from the front surface,
a display input region at the proximal end,
an ambient input region and an output region at the distal end,
one or more optical elements positioned in or adjacent to the waveguide to direct display light from the display input region to the output region and to direct ambient light from the ambient input region to the output region, and
a switchable mirror layer positioned in or on the waveguide to selectively control the amount of ambient light that is directed to the output region;
directing display light from a display into the display input region;
directing ambient light from a scene into the ambient input region; and
regulating the relative proportions of ambient light and display light seen by the user by controlling an electrical bias applied to the switchable mirror layer

31. The process of claim 30, further comprising regulating the relative proportions of ambient light and display light seen by the user by controlling brightness of the display.

32. The process of claim 30, further comprising:
measuring the intensity of the display light;
measuring the intensity of the ambient light; and
using the measured intensities to automatically regulate the relative proportions of ambient light and display light seen by the user by controlling the electrical bias, the brightness of the display, or both.
